(19) United States
(12) Patent Application Publication
(10) Pub. No.: US 2002/0100290 A1
(43) Pub. Date: Aug. 1, 2002

(54) Device for air conditioning of a motor vehicle interior

(76) Inventors: Magnus Herta, Olching (DE); Michael Nothen, Dietramszell (DE)

Correspondence Address: NIXON PEABODY, LLP, 8180 GREENSBORO DRIVE, SUITE 800, MCLEAN, VA, 22102, US

(21) Appl. No.: 10/026,954

(22) Filed: Dec. 27, 2001

(30) Foreign Application Priority Data
Dec. 29, 2000 (DE) 100 65 279.4

(51) Int. Cl. B60H 3/00; B61D 27/00; B60H 1/32; F25D 17/02

(52) U.S. Cl. 62/434; 62/244; 165/42; 165/902

(57) ABSTRACT

A device for air conditioning of a motor vehicle interior, with a refrigerant circuit which has a compressor (21), a condenser (22) and at least one evaporator (30), with a heat exchange medium circuit which has at least one heat source (engine 10, auxiliary vehicle heater 14) and at least one heat exchanger (12, 17). To simplify the system and to accelerate the response behavior when heating and cooling, it is provided that there an evaporator (30) of the refrigerant circuit and a heat exchanger (17) of the heat exchange medium circuit are both located in a reservoir (33) which is suited for selective storage of both heat and cold.

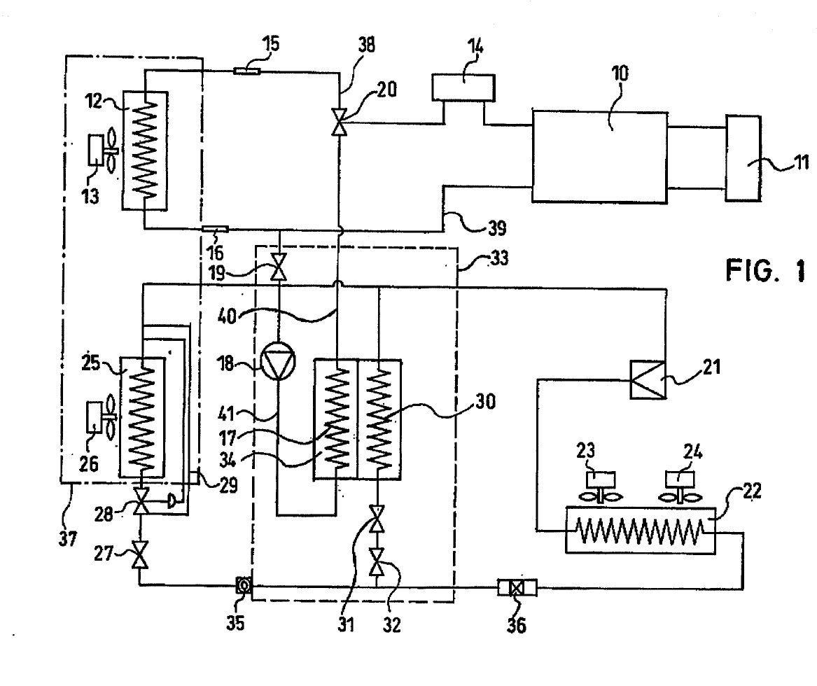

### BACKGROUND OF THE INVENTION

1. Field of the Invention

The invention relates to a device for air conditioning of a motor vehicle interior with a refrigerant circuit which comprises a compressor, a condenser, at least one evaporator, a heat exchange medium circuit which has at least one heat source and at least one heat exchanger, and at least one reservoir for storage of heat energy or cold energy.

2. Description of Related Art

An air conditioning device with a first refrigerant circuit which comprises a compressor, condenser and evaporator for cooling the vehicle interior, and a second refrigerant circuit which comprises another evaporator which is connected to the refrigerant reservoir and can be connected parallel to the first refrigerant circuit, is known from published German Patent Application DE 196 45 178 A1. To enable simple and comfortable auxiliary air conditioning, it is provided in the known device that a module comprised of an ice reservoir and a flat, second heat exchanger is located in one wall of the vehicle interior and can be directly connected by heat-transfer to the air of the vehicle interior. This known air conditioning device has proven itself in practice.

Another device for air conditioning of a vehicle interior with a first heat exchange medium circuit which has the engine of the motor vehicle, the radiator of the engine, an auxiliary vehicle heater independent of the engine, a heat reservoir and at least one heat exchanger for heating the vehicle interior, and with another heat exchanger which is connected to the cooling circuit and the refrigerant reservoir, is known from published German Patent Application DE 196 25 927 A1. This known device has proven itself in practice and represents a development in comparison to the initially mentioned known device, since it stores both heat energy and cold energy. Both reservoir measures contribute to saving energy; on the other hand, the high weight and the space requirement of the two reservoir units is a disadvantage in motor vehicles.

### SUMMARY OF THE INVENTION

In view of this prior art, a primary object of the present invention is to devise a simplified air conditioning device for a motor vehicle interior.

This object is achieved by the features described in greater detail below.

The invention combines the cold reservoir principle and the heat reservoir principle in an economical and energy-saving manner while increasing the reaction speed of the air conditioning process. The core of the invention is accordingly formed by the integration of the refrigerant reservoir and the heat exchange medium reservoir in a single reservoir which contains a common heat exchange heat/cold reservoir medium. The management of this reservoir takes place by a control means which controls the loading and unloading of the reservoir depending on the cooling requirement or heating requirement in the heat exchange medium circuit.

A cold refrigerant from the integral heat reservoir/cold reservoir is added to the heat exchange medium circuit to the required extent, preferably controlled by valves when there is a demand for cold in the vehicle interior, and vice versa, heat is purposefully supplied to the heat exchange medium circuit by the integral heat reservoir/refrigerant reservoir, when there is a corresponding demand for heat.

Advantageously, for environmental and cost reasons, the common reservoir medium is water which is often provided with antifreeze.

To eliminate the need for assemblies such as circulation pumps, as compared to the known separately executed air conditioning device based on cold reservoirs or heat reservoirs, they can be used jointly in the device in accordance with the invention so that the number is reduced.

The invention is detail below with reference to the accompanying drawings.

### BRIEF DESCRIPTION OF THE DRAWINGS

The sole FIGURE is a block diagram schematically showing one embodiment of the air conditioning device in accordance with the invention for the vehicle interior.

### DETAILED DESCRIPTION OF THE INVENTION

The heat exchange medium circuit comprises the motor vehicle engine 10, the radiator 11 for cooling the vehicle engine 10, a heat exchanger 12 with an assigned fan for delivering heated air into the vehicle interior 37 which is indicated schematically by dot-dash lines, and an auxiliary vehicle heater 14. In the feed line 38 from the auxiliary vehicle heater 14 to the heat exchanger 12 and in the discharge line 39 from the heat exchanger 12 to the motor vehicle engine 10 there are temperature sensors 15, 16, respectively.

The second part of the heat exchange medium circuit comprises another heat exchanger 17 which can be connected in parallel to the heat exchanger 12 and for this purpose can be connected using a flow line 40 and a return line 41 to the lines 38, 39 to/from the heat exchanger 12. In the flow line 40 to the other heat exchanger 17, there is a circulation pump 18. The flow line 40 to the other heat exchanger 17 contains a first solenoid valve 19 and the return line 41 contains a second solenoid valve 20 which is preferably designed as a three-way valve in the connection area to the feed line 38.

The first refrigerant circuit comprises a compressor 21, a condenser 22 to which two fans 23, 24 are assigned, and an evaporator 25 to which one fan 26 is assigned with which air is conveyed through the evaporator 25 and delivered into the vehicle interior 37 as cold air. In the connecting line of the evaporator 25 to the condenser 22 there is a solenoid valve 27, and furthermore, a viewing window 35 and a collector/drier 36. Another solenoid valve 28 is series connected to the solenoid valve 27 and controls a bypass line 29 of the evaporator 25.

The second part of the refrigerant circuit comprises another evaporator 30 which can be connected parallel to the evaporator 25. In the connecting line from the evaporator 30 to the refrigerant circuit there are an expansion valve 31 and a solenoid valve 32. The expansion valve 31 can also be located elsewhere in the refrigerant circuit.

The other evaporator 30 and the other heat exchanger 17 are located in a common heat reservoir/cold reservoir 33 or are combined into it, and it contains a common heat reservoir/cold reservoir medium 34 for example, in the form of water into which heat can be delivered by means of the heat exchanger 17 and cold can be delivered by means of the evaporator 25.

The part of the refrigerant circuit comprising the evaporator 25 is only an option. Under certain circumstances, it is sufficient to meet the demand for cold in the motor vehicle interior 37 via the heat exchanger 12 which absorbs cold energy by indirect heat exchange of the heat exchanger 17 with the evaporator 30.

Certain modes of operation of the air conditioning device in accordance with the invention for the vehicle interior are explained below.

First of all, it is assumed that the refrigerant circuit with the first evaporator 25 and the second evaporator 30 are not active.

When the vehicle is in operation, the motor vehicle engine 10 heats up. When there is a heat demand in the vehicle interior 37 and when a minimum temperature is reached in the heat exchange medium circuit, coolant flows which travels through the motor vehicle engine 10 to the heat exchanger 12. The fan 13 conveys air through the heat exchanger 12 in order to deliver it to the vehicle interior 37. The coolant flows from the motor vehicle engine 10 via the three-way solenoid valve 20 and the feed line 38 into the heat exchanger 12. After leaving the heat exchanger 12, the coolant flows via the discharge line 39 back to the motor vehicle engine 10. In this case or operating mode, it is assumed that the auxiliary vehicle heater 14 is not active since the vehicle is being driven.

In the case in which the motor vehicle is stopped or the heat demand cannot be met by the motor vehicle engine 10, alternatively or additionally, the auxiliary motor vehicle heater 14 is active and feeds heat into the coolant in the heat exchange medium circuit, in order, on the one hand, to heat the engine 10, and on the other to supply heat energy to the heat exchanger 12, so that the vehicle interior 37 can be heated via the fan 13. In the just explained operation with or without the auxiliary vehicle heater 14, the part of the heat exchange medium circuit which encompasses the other heat exchanger 17 is not operatively connected to the first heat exchange medium circuit. This is achieved by the solenoid valve 19 being set into a closed state and the circulation pump 18 not being actuated.

Starting at the time at which the heat exchange circuit produces excess heat, i.e., more heat than is to be delivered, for example, by the heat exchanger 12 into the vehicle interior 37, the second part of the heat exchange medium circuit is connected in parallel to the heat exchange medium circuit, i.e., the solenoid valve 19 is opened some and the circulation pump 18 is actuated so that the excess heat energy can travel into the other heat exchanger 17 and is stored there in the reservoir medium 34 of the integral heat reservoir/cold reservoir 33.

An operating mode is assumed below in which the motor vehicle air conditioning system is active, the second evaporator 30 not being operatively connected to the first evaporator 25. The motor vehicle air conditioning system produces cold which is transported by means of the refrigerant according to the requirements in the motor vehicle interior 37 to the evaporator 25. The air cooled by the evaporator 25 is delivered to the vehicle interior 37. In this case, proceeding from the uncharged heat reservoir/cold reservoir 33, first the second evaporator 30 is not connected to the first evaporator 25 as long as all the cold energy is needed for cooling the vehicle interior 37. As soon as this supply demand in the vehicle interior 37 is met and excess cold energy is produced by the air conditioning system, the second evaporator 30 is operatively connected in parallel to the first evaporator 25, i.e., the solenoid valve 32 is opened some so that the excess cold energy passes through the other evaporator 30 and is stored in the reservoir medium 34.

With the cold or heat stored in the reservoir 33, it is possible to proceed in different ways.

For example, in the case in which there is an increased cold demand in the vehicle interior 37 and the reservoir 33 contains stored cold, the second part of the heat exchange medium circuit is briefly connected to the heat exchanger 17, and in this case, the cold stored in the reservoir 33 being added to the heat exchange medium circuit by the heat exchanger 17 and supplied to the heat exchanger 12.

In the reverse case, in a similar manner with a strong demand for heat in the vehicle interior 37 and with heat energy stored in the reservoir 33, heat energy can be taken from the reservoir 33 by parallel connection of the second part of the heat exchange medium circuit with the heat exchanger 17 to the heat exchange medium circuit from the reservoir 33 in order to add it to the heat exchange medium and deliver it to the heat exchanger 12.

Summary of the possible operating modes:

A. Cooling of the vehicle interior from the reservoir (auxiliary cooling)

The reservoir medium 34 is cold due to prior operation of the compressor 21. The solenoid valve 19 is opened and the solenoid valve 20 connects the flow line 40 to the feed line 38. The circulation pump 18 circulates the heat exchange medium which has been cooled by the reservoir medium 34 through the heat exchangers 17 and 12.

B. Cooling of the vehicle interior by the motor vehicle air conditioning system via the reservoir

As soon as the temperature on the temperature sensor 16 or a pressure valve on the evaporator 30 signals that the cooling capacity of the reservoir 33 is exhausted, the compressor 21 starts and charges the reservoir 33 via the evaporator 30 again. The compressor 21 can only be operated with simultaneous operation of the motor vehicle engine 10. If, while driving, cooling is produced indirectly via the reservoir 33, it acts as a larger buffer, by which continuous turning on and off of an uncontrolled compressor is prevented and the cycles are prolonged.

C. Direct cooling via the air conditioning system

With high cold demand in the vehicle interior 37, the latter is exposed directly to refrigerant from the refrigerant circuit via the (optional) evaporator 25. The evaporator 25 can also be located in the air flow horizontally in succession with the heat exchanger 12 so that instead of the two fans 13 and 26, only a single fan is necessary.

D. Double cooling

With very high cold demand and with the reservoir 33 charged with cold energy, parallel operation of the two operating modes A and C can take place. Here, cold water is delivered via the heat exchanger 17 from the reservoir 33 into the heat exchanger 12 and in addition refrigerant is delivered to the evaporator 25.

E. Preheating from the reservoir

When the reservoir medium 34 is warm from prior operation of the motor vehicle engine 10 and/or the auxiliary vehicle heater 14, with the solenoid valves 19 and 20 opened, hot water can be delivered by the circulation pump 18 through both of the heat exchangers 17 and 12.

F. Preheating or heating by the auxiliary motor vehicle heater

With the solenoid valve 19 closed, the heat exchange medium is delivered by a circulation pump integrated into the auxiliary motor vehicle heater 14 through the heat exchanger 12.

G. Preheating or heating by the auxiliary motor vehicle heater and reservoir or charging of the reservoir by the auxiliary motor vehicle heater

With the reservoir 33 charged, the operating modes E and F can be combined for especially prompt preheating of the vehicle interior 37. In doing so, the heat exchange medium flows through the auxiliary motor vehicle heater 14 which can also be located in the feed line 38 between the solenoid valve 20 and the heat exchanger 12, through the heat exchanger 12 and the heat exchanger 17. The solenoid valves 19 and 20 are opened accordingly and the circulation pump 18 is in operation. The same circuit connection can also be used for charging the reservoir 33 by means of the auxiliary motor vehicle heater 14 when the heat energy produced by the auxiliary motor vehicle heater 14 is greater than the energy removed by the heat exchanger 12.

H. Additional heating with the motor vehicle engine

In the above described operating modes E, F, and G, the motor vehicle engine 10 can also be in operation. Thus, three heat sources, i.e., the motor vehicle engine 10, the auxiliary motor vehicle heater 14, and the reservoir 33 can be selectively or simultaneously interconnected in the heat exchange medium circuit. Depending on the heat state of the individual heat sources and after heat dissipation on the heat exchanger 12, the motor vehicle engine 10 can be preheated by the auxiliary motor vehicle heater 14 and/or the reservoir 33 or can feed heat energy into the heat exchange medium circuit which is then used, for example, to charge the reservoir 33.

What is claimed is:

1. Device for air conditioning of a motor vehicle interior, comprising:
a refrigerant circuit with a compressor, a condenser and at least one evaporator;
a heat exchange medium circuit which has at least one heat source and at least one heat exchanger; and
at least one reservoir for storage of heat energy or cold energy,
wherein at least one of the at least one evaporator of the refrigerant circuit and wherein at least one of the at least one heat exchanger of the heat exchange medium circuit are located jointly in a reservoir which is adapted for the selective storage of heat and cold.

2. Device as claimed in claim 1, wherein the heat exchanger in the reservoir is selectively connectable and disconnectable from fluid communication with the heat exchange medium circuit by at least one valve.

3. Device as claimed in claim 2, wherein the evaporator in the reservoir is selectively connectable and disconnectable from fluid communication with the refrigerant circuit by at least one valve.

4. Device as claimed in claim 1, wherein the evaporator in the reservoir is selectively connectable and disconnectable from fluid communication with the refrigerant circuit by at least one valve.

5. Device as claimed in claim 1, wherein the evaporator and the heat exchanger in the reservoir are in direct heat conductive connection with each other.

6. Device as claimed in claim 1, wherein the evaporator and the heat exchanger in ther reservoir are connected in a heat conductive manner via a reservoir medium which is located in the reservoir.

7. Device as claimed in claim 1, wherein in the refrigerant circuit comprises at least a second evaporator via which air cooled by a fan is routed to a vehicle interior space.

8. Device as claimed in claim 1, wherein a heat exchanger assigned to a vehicle interior space is provided in the heat exchange medium circuit, and wherein at least one valve is provided by which the heat exchanger assigned to a vehicle interior space is selectively connectable to at least one of a heat source and the heat exchanger in the reservoir.

9. Device as claimed in claim 1, wherein a circulation pump is provided in the heat exchange medium circuit which is independent of the engine.

10. Device as claimed in claim 1, further comprising an auxiliary vehicle heater in the heat exchange medium circuit, and wherein the circulation pump is independent of the auxiliary vehicle heater.
